(19) United States
(12) Patent Application Publication
(10) Pub. No.: US 2012/0293552 A1
(43) Pub. Date: Nov. 22, 2012

(54) Method And Apparatus For Display Zoom Control Using Object Detection

(76) Inventors: James William McGowan, Whitehouse Station, NJ (US); Ralf Klotsche, Neuenburg (DE)

(21) Appl. No.: 13/109,539

(22) Filed: May 17, 2011

(51) Int. Cl. G09G 5/00

(52) U.S. Cl. 345/660

(57) ABSTRACT

A zoom method and apparatus utilizing object detection. For example, some embodiments allow a user to zoom in or out from the digital content being displayed by moving their head towards or away from the display screen.

### TECHNICAL FIELD

The invention relates generally to methods and apparatus for zooming displayed digital content.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

There are numerous techniques allowing a user to zoom digital content on a display.

### SUMMARY

Various embodiments provide a zoom method and apparatus utilizing object detection. For example, some such embodiments may allow a user to zoom in or out from digital content being displayed on a device by moving their head towards or away from the display screen.

In one embodiment, a method is provided for controlling zoom of digital content data. The method includes retrieving a first object position within a first frame; retrieving a second object position within a second frame; determining a shifted location for a digital content data based on the first object position and the second object position; determining a zoom factor for the digital content data based on the first size and the second size; determining a zoom control signal based on the shifted location and the zoom factor and outputting the zoom control signal.

In another embodiment, an apparatus is provided controlling zoom of digital content data. The apparatus includes a processor and digital data storage configured to receive a first object position within a first frame; receive a second object position within a second frame; determine a shifted location for a digital content data based on the first object position and the second object position; determine a zoom factor for the digital content data based on the first object position and the second object position; determine a zoom control signal based on the shifted location and the zoom factor; and output the zoom control signal.

In yet another embodiment, an apparatus is provided controlling zoom of digital content data. The apparatus includes an image detector configured to capture a plurality of digital frames, a display configure to display a digital image and a processor and digital data storage. The processor and digital data storage are configured to determine a shifted location and zoom factor based on at least two of the plurality of digital frames captured by the image detector and to display digital content data on the display based on the zoom factor and the shifted location.

### BRIEF DESCRIPTION OF THE DRAWINGS

Various embodiments are illustrated in the accompanying drawings, in which:

FIG. 1 depicts a block diagram schematically illustrating functional blocks of a method for controlling zoom;

FIG. 2 depicts a flow chart illustrating an embodiment of a method for controlling zoom referring to the functional blocks of FIG. 1;

FIG. 3 depicts a flow chart illustrating an embodiment of a method for controlling zoom using the zoom controller of FIG. 1;

FIG. 4 depicts a block diagram schematically illustrating an embodiment of a zoom controller of FIGS. 1; and

FIG. 5 depicts a block diagram schematically illustrating an embodiment of a zoom apparatus referring to the functional blocks of FIG. 1.

To facilitate understanding, identical reference numerals have been used to designate elements having substantially the same or similar structure and/or substantially the same or similar function.

### DETAILED DESCRIPTION OF ILLUSTRATIVE EMBODIMENTS

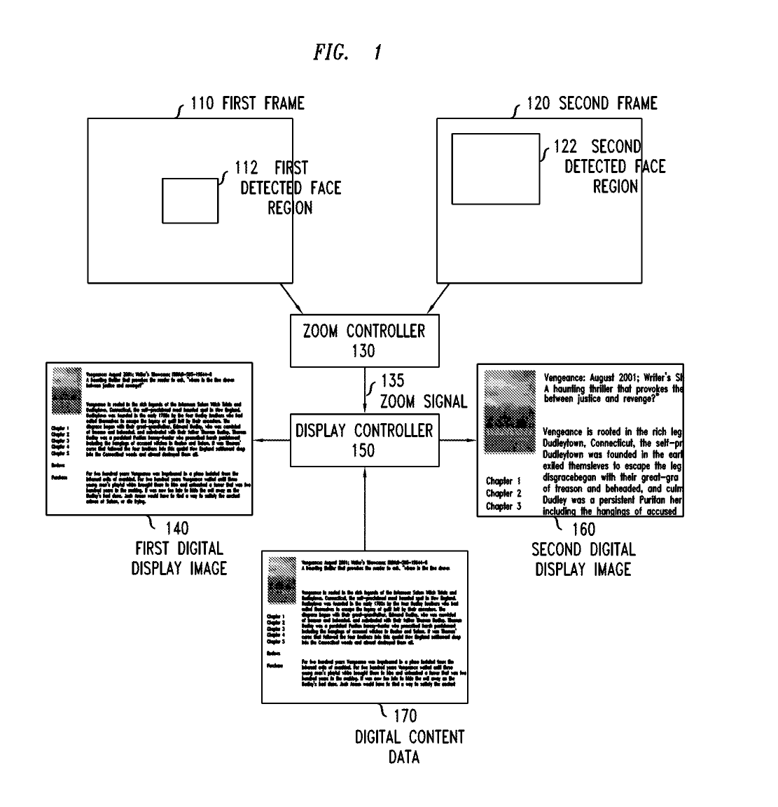

FIG. 1 illustrates a functional block diagram depicting an exemplary method of providing zoom control of displayed digital content using face detection. First and second frames 110 and 120 are two images captured by an image detector, such as a camera, at two points in time. First and second detected face regions 112 and 122 are regions within the captured frames where a face has been detected. The zoom controller 130 takes inputs defining the location and size of the first and second detected face regions and outputs a zoom control signal 135 based on changes in location and size between the first detected face region 112 and the second detected face region 122. A display controller 150 controls display of digital content data 170 based on the inputted zoom control signal 135. In the functional block diagram, digital display image 140 is an exemplary image displayed by display controller 150 at a first point in time and digital display image 160 is an exemplary image displayed by display controller 150 at a second point in time after receiving the zoom control signal 150 created based on the changes between detected face regions 112 and 122.

Frames 110 and 120 are images captured by an image detector (not shown) directed towards a user viewing the digital display images 140 and 160. Detected face regions 112 and 122 are the estimated location and size of the user's face detected within captured frames 110 and 120 as will be explained herein. For example, as illustrated in FIG. 1, in the second frame 120, the user's face has moved closer as compared to the first frame 110, e.g., the second detected face region 122 is larger than first detected face region 112. Additionally, the user's face has moved toward the top left of the screen, e.g., the second detected face region 122 is located above and to the left when compared to the first detected face region 112.

Zoom controller 130 uses information of the location and sizes of the detected face regions 112 and 122 to output a zoom control signal 135. The zoom control signal 135 indicates the changes in user view position based on the differences in location and size of the detected face regions 112 and 122.

Display controller 150 controls the display of digital content data 170 based on the zoom control signal 135. For example, as illustrated in FIG. 1, the first digital display image 140 represents an initial image displayed to the user containing the entirety of the digital content data 170. As illustrated, the second digital display image 160 represents the display presented to a user after the zoom control signal 135 has been applied by the display controller to the digital content data 170. As illustrated, the second digital image 160 has been magnified (i.e., zoomed in) and the position shifted to display the upper left portion of the digital content data after the zoom control signal 135—representing the change in location and size of the detected faces 112 and 122—has been applied to the digital content data.

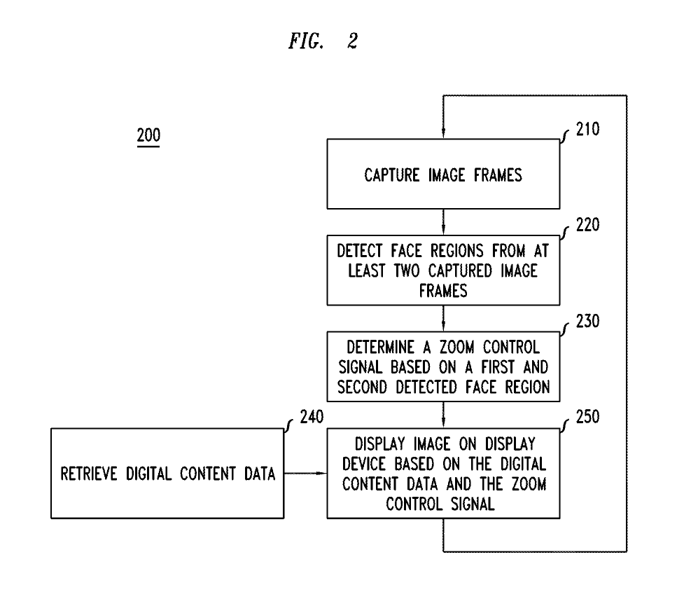

FIG. 2 shows a flow diagram of a method 200 for providing a zoom controlled display as illustrated in the functional blocks of FIG. 1. The method 200 includes capturing image frames (step 210), such as first and second frames 110 and 120 in FIG. 1, and then detecting face regions from at least two captured image frames (step 220), such as first and second detected face regions 112 and 122 in FIG. 1. Based on the first and second detected face regions, method 200 determines a zoom control signal (step 230), such as zoom control signal 135 in FIG. 1. The method then retrieves the digital content data for display to the user (step 240), such as digital content data 170 in FIG. 1, and displays the digital content data on a display based on the zoom control signal (step 250), such as display controller 150 in FIG. 1 displaying first and second digital display images 140 and 160 in FIG. 1.

In the method 200, the step 210 includes capturing image frames. In particular, an image detector directed at a user viewing a display screen captures a plurality of images of the user over a period of time.

In the method 200, the step 220 includes detecting face regions from at least two image frames captured in step 210. In particular, a conventional face detection module analyzes the digital image data in a captured frame and detects regions of the image where faces may be present and returns parameters defining the detected face region.

In the method 200, the step 230 includes determining a zoom control signal based on a first and second face region detected during step 220. The zoom control signal is based on the change in location and relative size between the first and second detected face regions.

In the method 200, the step 240 includes retrieving digital content data. The digital content data is the image to be displayed to the user.

In the method 200, the step 250 includes displaying the digital content data on a display based on the zoom control signal. The digital content to be displayed to the user is formatted for display based on the zoom control signal.

After step 250, method 200 returns to step 210 to repeat the process of adjusting the display image based on changes in the detected face regions as compared from a prior frame to the current frame. It may be appreciated that in some embodiments, the new first detected face region may be set to a prior detected face region from a prior captured image frame (e.g., the prior second detected face region). Thus, in this embodiment, one captured image frame in step 210 and one detected face region in step 220 may be used from a prior iteration of the method 200.

In some embodiments of the method 200, a delay is introduced between display step 250 and receiving step 210. The delay may advantageously allow a user's eyes a time period to adjust to the newly displayed image and avoid erroneously adjustments while a user finds their shifted point of interest in the digital content data.

It may be appreciated that the digital content data may be any digital content of interest to the user. For example, digital content may include: a web page or document downloaded from the internet, an e-book or document stored on the device, and/or the like.

In a first embodiment of the method 200, the zoom controlled apparatus may be a cellular telephone including a display and a camera. The camera is directed to the user viewing the digital content and periodically captures frames (i.e., images) of the user viewing the display (e.g., step 210). The cellular telephone may include an application that analyzes the captured images and determines whether a face has been detected and the location and size of any detected face regions (e.g., step 220). The cellular telephone may then be programmed to compare a first and second detected face region to determine the zoom control signal (e.g., step 230). Based on the zoom control signal, the cellular telephone displays a portion of the digital content on the display for the user to view (e.g., steps 240 and 250).

In a second embodiment, a camera may be directed away from the user viewing the screen. In this embodiment, a stationary object that has a recognizable pattern may be used in place of the detected face regions. It may be appreciated that the object being detected in this embodiment may advantageously be an object within the same image being displayed on the apparatus and thus, movement of the camera toward or away from the object may provide automated zooming away from or toward the image being viewed by the user. Automated zooming may provide for applications such as automated camera zooming when taking a picture or when using an apparatus, such as a camera, as a magnifying glass.

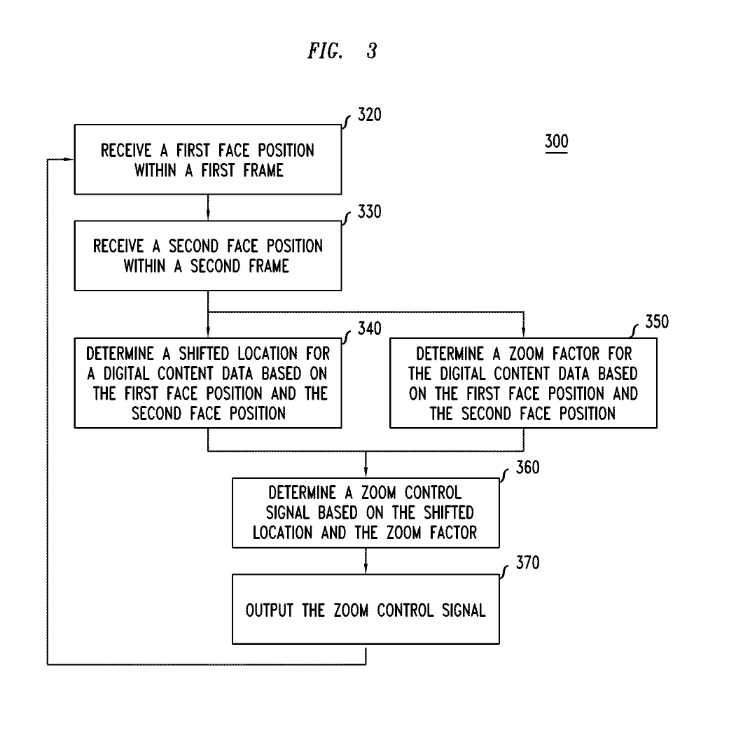

FIG. 3 shows a flow diagram of a method 300 for providing zoom control as illustrated by the zoom controller of FIG. 1. The method 300 includes receiving a first face position detected within a first frame (step 320) at a first point in time and receiving a second face position detected within a second frame (step 330) at a second point in time. The method 300 then determines a shifted location and a zoom factor based on the first and second face positions (steps 340 and 350), determines a zoom control signal based on the shifted location and the zoom factor (step 360) and then outputs the zoom control signal (step 370).

In the method 300, the step 320 includes receiving a first face position within a first frame. In particular, the first face position includes parameters that define the region of the frame where a face is present. The parameters enable specifying the location and size of the detected face region.

In the method 300, the step 330 includes receiving a second face position within a second frame. In particular, the second face position includes parameters that define the region of the frame where a face is present. The parameters enable specifying the location and size of the detected facial region.

In the method 300, the step 340 includes determining a shifted location for digital content data. The shifted location is based on the first and second face positions and corresponds to a new positioning location for displaying the digital content data. In one embodiment, the shifted location corresponds to a position within the digital content data representing the center of the portion of the digital content data meant to be displayed.

In the method 300, the step 350 includes determining a zoom factor. The zoom factor corresponds to a factor in which the zoom controller determines the desired level of zoom of the digital content data based on the first and second face positions.

In the method 300, the step 360 includes determining a zoom control signal based on the shifted location and the zoom factor. The zoom control signal corresponds to any suitable signal that may assist a display controller (e.g., 150 in FIG. 1) in identifying the portion of the digital content data to display.

In the method 300, the step 370 includes outputting the zoom control signal.

After step 370, method 300 returns to step 320 to repeat the process of determining zoom parameters based on changes in the detected face regions as compared from a prior frame to the current frame. It may be appreciated that in some embodiments, the new first face position may be set to a prior face position (e.g., the prior second face position). Thus, in this embodiment, the first detected face region in step 320 may be received during a prior iteration of the method 300.

In a first embodiment of the method 300, the format of the face positions received in steps 220 and 230 may be an xy coordinate value identifying the top left portion of the detected face region (e.g., 112 or 122 in FIG. 1) and a height and width parameter identifying the size of the detected face region. In a second embodiment, the format of the received face positions may be two xy coordinate values: the first xy coordinate value identifying the top left of the detected face region and the second xy coordinate value identifying the bottom right of the detected face region. In the second embodiment, the size may be derived from the pair of xy coordinates which define the detected face region. In a third embodiment, the format of the received face positions may be an xy coordinate specifying the center of the detected face region and a radius specifying the size of the region. It may be appreciated that any suitable format that allows the method 300 to determine changes in location and size between the first and second detected face positions may be used.

In some embodiments of the method 300, one or both of receiving steps 320 and 330 may further include receiving a count of how many face regions were detected in the frame. Steps 320 and 330 may then select a technique to enable analyzing the same face regions in the frames of steps 320 and 330. One technique is to select the largest detected face region. It may be appreciated that the largest detected face region may have a higher likelihood of being the region representing the user viewing the digital content data on the display.

In some embodiments of the method 300, receiving step 330 may further include receiving frame face positions from a plurality of frames until the received frame face position has substantially changed from the first face position and then setting the second face position to the received frame face position. Suppressing determination of the second face position until substantial movement has been determined has the advantage of squelching changes based on normal hand movement, e.g., shaking. Determination of a substantial change may be any suitable technique where the position change between the frame face position and the first face position is determined to be less than a predetermined value. For example, pseudo code lines (1)-(3) demonstrate one determination technique.

(1) change =

abs( SecondFacePosition[‘x’] − FirstFacePosition[‘x’] ) +

abs( SecondFacePosition[‘y’] − FirstFacePosition[‘y’] )

(2) if change < threshold

FaceHasMoved = False

(3) else

FaceHasMoved = True

In some embodiments of the method 300, one or both of receiving steps 320 and 330 may further include receiving frame face positions from a plurality of frames until the received frame face position has remained stable over a predetermined number of frames and then setting the respective first or second face position to the received frame face position. Forcing the frame face position to remain stable over a number of frames may remove spurious results (e.g., as when the user first lifts the phone) and/or lessen the changes that need to be made.

It may be appreciated that in some embodiments of the method 300, one or both of the receiving steps 320 and 330 may be with regard to detection of an object other than a face and a detection method other than face detection. For example, image recognition techniques may be used to identify a stationary object to be used as the reference object. In the same way that the position and size of the detected face is used to determine a change in user view position, the change in the first and second reference object positions and sizes may be used as inputs into steps 340 and 350.

In some embodiments of the method 300, determining a shifted location for the digital content data (e.g., 170 in FIG. 1) in step 340 includes determining the shift in position between a first detected face region (e.g., 112 in FIG. 1) and a second detected face region (e.g., 122 in FIG. 1) and applying the shift of position to determine the center of the digital display image (e.g., 140 and 160 in FIG. 1) that will be displayed to the user. It may be appreciated that any suitable technique providing a determined shifted location may be used.

In one embodiment, the method steps 320 and 330 receive face position information in the form of a xy coordinate representing the upper left of the detected face region (e.g., 112 and 122 in FIG. 1) and a width and height parameter defining the size of the region. In a further embodiment, pseudo code lines (4)-(11) demonstrate one technique for determining the shifted location for the digital content data in step 340. In this embodiment, absolute coordinates 0-1.0 are used to represent the display screen coordinates. For example, for a screen with a resolution of 320×240, xy coordinates 0.5, 0.5 would represent the center of the screen (i.e., xy coordinate 160×120). It may be appreciated that by using an absolute coordinate system, method 300 may simplify handling different screen resolution.

(4) FirstCenterX = ( FirstFacePosition[‘x’] +

( FirstFacePosition[‘width’] / 2 ) ) / FirstFrameWidth

(5) FirstCenterY = ( FirstFacePosition[‘y’] +

( FirstFacePosition[‘height’] / 2 ) ) / FirstFrameHeight

(6) SecondCenterX = ( SecondFacePosition[‘x’] +

( SecondFacePosition[‘width’] / 2 ) ) / SecondFrameWidth

(7) SecondCenterY = ( SecondFacePosition[‘y’] +

( SecondFacePosition[‘height’] / 2 ) ) /

SecondFrameHeight

```
  (8) ShiftX = FirstCenterX − SecondCenterX
  (9) ShiftY = FirstCenterY − SecondCenterY
(10) DigitalContentDataCenterX = 0.5 − ShiftX
(11) DigitalContentDataCenterY = 0.5 − ShiftY
```

In this embodiment above, a center xy coordinate for a first detected face (e.g., 112 in FIG. 1) is determined in lines (4)-(5) and a center xy coordinate for a second detected face (e.g., 122 in FIG. 1) is determined in lines (6)-(7). Lines (8)-(9) determine the shift between the center of the first and second face regions. The determined shift is then used to determine the shifted location. In this embodiment, the shifted location is a new center position of the digital content data (e.g., 170 in FIG. 1) as shown in lines (10)-(11). Advantageously, the center of a second digital display image (e.g., 160 in FIG. 1) displayed to a user may then be based on the new center position.

In some embodiments of the method 300, determining a zoom factor for the digital content data (e.g., 170 in FIG. 1) in step 350 includes determining the change in region size between a first detected face region (e.g., 112 in FIG. 1) and a second detected face region (e.g., 122 in FIG. 1) and applying the change in region size to determine the zoom factor of the digital display image (e.g., 140 and 160 in FIG. 1) that will be displayed to the user. It may be appreciated that any suitable technique equating change in size between first and second detected face regions to zoom factor may be used. In one embodiment, pseudo code lines (12)-(14) demonstrate one technique for determining the zoom factor.

(12) WidthRatio = FirstFacePosition[‘width’] /

SecondFacePosition[‘width’]

(13) HeightRatio = FirstFacePosition[‘height’] /

SecondFacePosition[‘height’]

(14) ZoomFactor = (WidthRatio + HeightRatio) / 2

It may be appreciated that the zoom factor may be advantageously used to zoom in or out of the digital content data (e.g., 170 in FIG. 1) being displayed to the user (e.g., 140 and 160 in FIG. 1). Any suitable technique may be used to zoom the information displayed to the user. In one embodiment, a zoom indicating a user has moved their first detected face position (e.g., 112 in FIG. 1) closer as compared to a second detected face position (e.g., 122 in FIG. 1) indicates that the digital content data should be zoomed in. For example, if the second detected face width and height is twice the length of the first detected face width and height, pseudo code lines (12)-(14) would compute a zoom factor of 0.5 indicating to zoom in by a factor of 2, or in other words, to display a portion of the digital content data that has a width and height of 0.5 (i.e., half) of the full digital content data.

In a further embodiment of the method 300, the determining a shifted location for the digital content data in step 340 further includes basing the determination from a first digital display image (e.g., 140 in FIG. 1) that already is zoomed and/or has a center position that is off-center. Pseudo code lines (15)-(16) replace pseudo code lines (10)-(11) in demonstrating one technique for determining the shifted location for the digital content data in step 340 taking into account a prior digital display image that is zoomed and/or off center.

(15) DigitalContentDataCenterX =

LastDigitalContentDataCenterX − ( ShiftX /
LastZoomFactor)

(16) DigitalContentDataCenterY =

LastDigitalContentDataCenterY − ( ShiftY /
LastZoomFactor)

As an example, the first digital display image may display only the lower right quadrant of the digital content data. The digital display image in this example may be defined by coordinates: 0.5, 0.5 and 1.0, 1.0. Further, if the second detected face position shifts to the upper left of the second frame, presumably to view the upper left portion of the first digital display image, the center should not shift all of the way to 0.0, 0.0, but rather to the upper left of the displayed image, e.g., 0.5, 0.5. In using code lines (12)-(13) to determine the center xy coordinates of the digital content data, the LastDigitalContentDataCenterX and LastDigitalContentDataCenterY are both 0.75; the ShiftX and ShiftY are both 0.5 and the LastZoomFactor is 2. Thus, DigitalContentDataCenterX and DigitalContentDataCenterY are properly determined to be 0.5.

In a further embodiment of the method 300, the determining a shifted location for the digital content data in step 340 further includes quantizing the digital content center value. Since there are many variables affecting the captured images, quantization provides a coarse adjustment sufficient for display and that advantageously minimizes the jitter that may be caused by a multitude of fine adjustments due to unintentional minor changes between the first and second detected face region (e.g., 112 and 122 in FIG. 1). Pseudo code lines (17)-(20) replace pseudo code lines (10)-(11) in demonstrating one technique for quantizing the digital content center value.

| (17) DigitalContentDataCenterX = 0.5 − _quantize( ShiftX, 10 ) | |
|---|---|
| (18) DigitalContentDataCenterY = 0.5 − _quantize( ShiftY, 10 ) | |
| Where the quantization routine may be: | |
| (19) def _quantize( val, quantFactor ) | |
| (20) | return round( val * quantFactor ) / quantFactor |

In some embodiments of the method 300, the shifted location and zoom factor determined in steps 340 and 350 may be determined at the same time and/or may be embodied in the same output. For example, the output may be derived using one equation that returns a first and second xy position defining the upper left and lower right portion of the digital content data to display. It will be appreciated that a shifted location and zoom factor may be embodied in and derived from the first and second xy positions.

In some embodiments of the method 300, the zoom control signal 370 is the shifted location and the zoom factor. In other embodiments, the zoom control signal 370 may contain additional information or modify the shifted location and zoom factor. For example, the zoom control signal may contain an xy position, a height and a width combination. It may be appreciated that the zoom control signal may be formatted in any suitable way that may be used by a display controller (e.g., 150 in FIG. 1). It may also be appreciated that the zoom control signal may be delivered in any suitable way to a display controller. For example, the zoom output signal may be parameters returned from a program or routine within a program.

In some embodiments of the method 300, a delay is introduced between output step 370 and receiving step 320. The delay may advantageously allow a user's eyes a time period to adjust to the newly displayed image and avoid erroneously adjustments while a user finds his shifted point of interest in the digital content data.

Although primarily depicted and described in a particular sequence, it may be appreciated that the steps shown in methods 200 and 300 may be performed in any suitable sequence. Moreover, the steps identified by one box may also be performed in more than one place in the sequence.

It may be appreciated that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

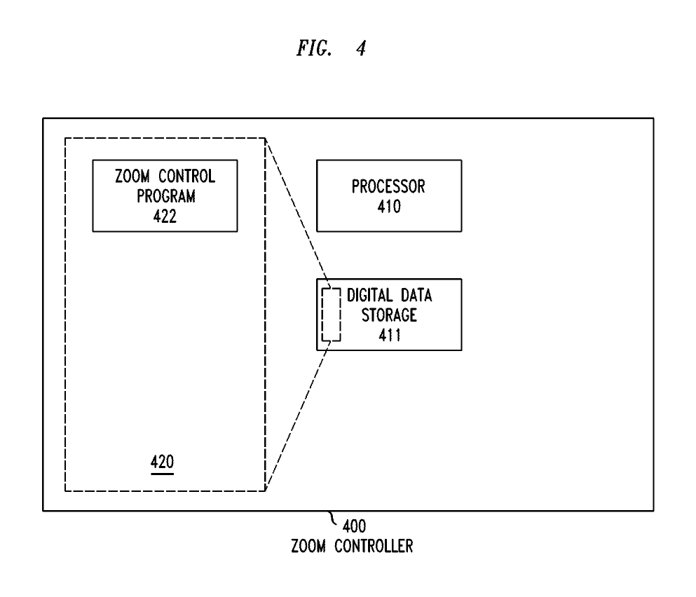

FIG. 4 schematically illustrates one embodiment of the zoom controller 130 of FIG. 1 for providing zoom control, e.g., using the methods of FIGS. 2 & 3. The zoom controller 400 includes a processor 410, a digital data storage 411 and a processor-executable programs 420 that are executable by the processor 410.

The processor 410 controls the operation of zoom controller 400. The processor 410 cooperates with the digital data storage 411.

The digital data storage 411 stores programs 420 executable by the processor 410.

The processor-executable programs 420 include a zoom control program 422. Processor 410 cooperates with digital data storage 411 to execute the zoom control program 422 to perform the step 230 in FIG. 2 and the steps of method 300 in FIG. 3.

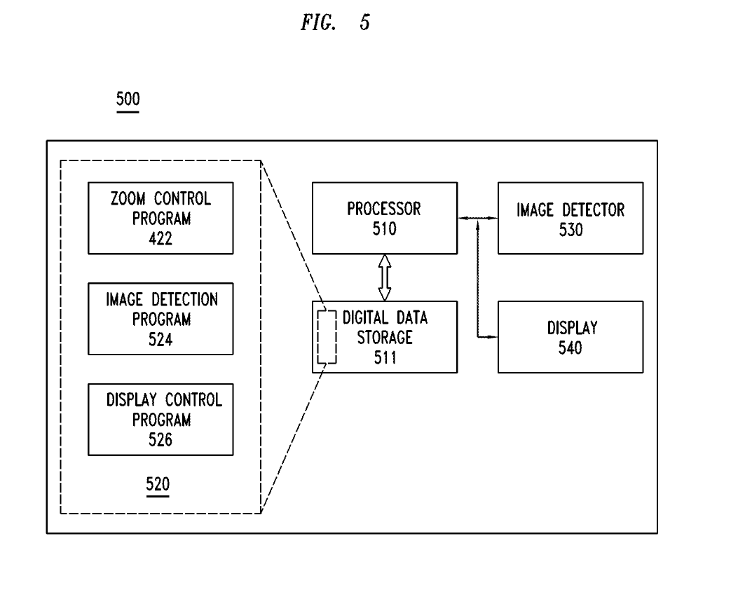

FIG. 5 schematically illustrates one embodiment of the zoom control apparatus for providing zoom control, e.g., using the methods of FIGS. 2 & 3. The zoom control apparatus 500 includes a processor 510, a digital data storage 511, a processor-executable programs 520 that are executable by the processor 510, an image detector 530 and a display 540.

The processor 510 controls the operation of zoom control apparatus 500. The processor 510 cooperates with the digital data storage 511.

The digital data storage 411 stores programs 420 executable by the processor 410.

The processor-executable programs 520 include a zoom control program 422, an image detection program 524 and a display control program 526. Processor 510 cooperates with digital data storage 511 to execute the zoom control program 422 as described in FIG. 4, to execute the image detection program 524 to perform the steps 210 and 220 in FIGS. 2, and to execute the display control program 526 to perform the steps 240 and 250 in FIG. 2.

In the apparatus 500, the image detector 530 may be a conventional image capture device. For example, the image detector 530 may be a conventional camera or video recorder.

In the apparatus 500, the display 540 may be a conventional display. For example, the display may be a conventional LCD, LED, OLED or any other display suitable for displaying digital content.

It may be appreciated that any suitable device capable of displaying digital content and containing an image detection interface may be used. For example, suitable devices may include: a smart phone, an e-book reader, a tablet, a personal computer, or the like.

In a first embodiment of the apparatus 500, the camera and display are operatively facing the same direction to enable the camera to take image frames of the user viewing the display. In a second embodiment of the apparatus 500, the camera and display are operatively facing opposing directions.

Although depicted and described herein with respect to embodiments in which, for example, programs and logic are stored within the digital data storage and the memory is communicatively connected to the processor, it may be appreciated that such information may be stored in any other suitable manner (e.g., using any suitable number of memories, storages or databases); using any suitable arrangement of memories, storages or databases communicatively coupled to any suitable arrangement of devices; storing information in any suitable combination of memory(s), storage(s) and/or internal or external database(s); or using any suitable number of accessible external memories, storages or databases. As such, the term digital data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It may be appreciated that any block diagrams herein represent conceptual views of illustrative circuitry embodying the principles of the invention. Similarly, it may be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. A method, comprising:
receiving, by a processor in cooperation with a digital data storage, a first object position within a first frame;
receiving, by the processor in cooperation with the digital data storage, a second object position within a second frame;
determining, by the processor in cooperation with the digital data storage, a shifted location for a digital content data based on the first object position and the second object position;
determining, by the processor in cooperation with the digital data storage, a zoom factor for the digital content data based on the first object position and the second object position;
determining, by the processor in cooperation with the digital data storage, a zoom control signal data based on the shifted location and the zoom factor; and
outputting, by the processor in cooperation with the digital data storage, the zoom control signal.

2. The method of claim 1, wherein the first object position is a first face position and the second object position is a second face position.

3. The method of claim 2, wherein the first face position comprises a first location and a first size and the second face position comprises a second location and a second size.

4. The method of claim 1, wherein the determining of the shifted location is further based on a prior center display image location of the digital content data.

5. The method of claim 4, wherein the prior center display image location is a location other than the center of the digital content data.

6. The method of claim 3, wherein the receiving of the second face position comprises:
receiving a frame face position from at least one frame; and
setting the second face position to the received frame face position if the received frame face position has substantially changed from the first face position.

7. The method of claim 6, wherein the setting of the second face position comprises:
determining whether the frame face position has remained stable over a predetermined number of frames; and
setting the second face position to the received frame face position if the received frame face position has substantially changed from the first face position and the received frame face position has remained stable over the predetermined number of frames.

8. The method of claim 7, further comprising:
receiving a face detection indication from at least a subset of the plurality of frames; and
returning the method to receiving the first face position if the face detection indication indicates no faces have been detected in a predetermined number of frames.

9. The method of claim 8, wherein the predetermined number of frames indicating no face detection is greater than 1.

10. The method of claim 2, further comprising:
capturing a plurality of image frames;
detecting the first face position and the second face position face from the plurality of captured image frames;
retrieving the digital content data; and
displaying a digital display image on a display screen based on the shifted location, the zoom factor and the digital content data.

11. An apparatus, comprising:
a processor and a digital data storage configured to:
receive a first object position within a first frame;
receive a second object position within a second frame;
determine a shifted location for a digital content data based on the first object position and the second object position;
determine a zoom factor for the digital content data based on the first object position and the second object position;
determine a zoom control signal based on the shifted location and the zoom factor; and
output the zoom control signal.

12. The apparatus of claim 11, wherein the first object position is a first face position and the second object position is a second face position.

13. The apparatus of claim 12, wherein the first face position comprises a first location and a first size and the second face position comprises a second location and a second size.

14. An apparatus, comprising:
an image detector configured to capture a plurality of digital frames;
a display configured to display a digital image; and
a processor and a digital data storage configured to:
determine a shifted location based on at least two of the plurality of digital frames;
determine a zoom factor based on at least two of the plurality of digital frames; and
display a digital content data on the display based on the zoom factor and the shifted location.

15. The apparatus of claim 14, wherein the image detector and the display are operatively facing in the same direction.

16. The apparatus of claim 14, wherein the processor and the digital data storage are further configured to:
receive a first object position within a first of the plurality of digital frames;
receive a second object position within a second of the plurality of digital frames;
determine the shifted location based on the first object position and the second object position; and
determine the zoom factor based on the first object position and the second object position.

17. The apparatus of claim 16, wherein the first object position is a first face position and the second object position is a second face position.

18. The apparatus of claim 17, wherein the first face position comprises a first location and a first size and the second face position comprises a second location and a second size.

19. The apparatus of claim 17, wherein the receiving of the second face position comprises:
receiving a frame face position from at least one of the plurality of digital frames; and
setting the second face position to the received frame face position if the received frame face position has substantially changed from the first face position.

20. The apparatus of claim 17, wherein the receiving of the second face position comprises:
receiving a frame face position from at least one of the plurality of digital frames;
determining whether the frame face position has remained stable over a predetermined number of frames; and
setting the second face position to the received frame face position if the received frame face position has remained stable over the predetermined number of frames.
